(19) United States
(12) Patent Application Publication
(10) Pub. No.: US 2024/0004106 A1
(43) Pub. Date: Jan. 4, 2024

(54) METASURFACE DEVICE, PREPARATION METHOD THEREOF, AND OPTICAL IMAGING SYSTEM

(71) Applicant: Shphotonics Ltd, Suzhou (CN)

(72) Inventors: Lei SUN, Suzhou (CN); Shanfeng QIU, Suzhou (CN); Bing QIU, Suzhou (CN)

(21) Appl. No.: 18/341,894

(22) Filed: Jun. 27, 2023

(30) Foreign Application Priority Data
Jul. 1, 2022 (CN) 202210779396.9

(51) Int. Cl. G02B 3/00

(52) U.S. Cl. CPC G02B 3/0056; G02B 3/0075

(57) ABSTRACT

A metasurface device includes a plurality of metasurface units and a flexible connection structure. The plurality of metasurface units are arranged in a plane shape spaced apart from each other. Each metasurface unit of the plurality of metasurface units includes a substrate and a plurality of nanostructure units arranged on a side of the substrate. The flexible connection structure connects the plurality of metasurface units.

### CROSS-REFERENCE TO RELATED APPLICATION

This application claims priority to Chinese Application No. 202210779396.9, filed on Jul. 1, 2022, the entire content of which is incorporated herein by reference.

### TECHNICAL FIELD

The present disclosure relates to the optical imaging technology field and, in particular, to a metasurface device, a preparation method of the metasurface device, and an optical imaging system.

### BACKGROUND

In the relevant technology, since the structure of an optical module, e.g., in a cell phone, an augmented reality apparatus, or a virtual reality apparatus, needs to meet a certain optical path requirement, the optical module is thick and has low light-transmission efficiency. Conventional optical imaging technology, such as that used in a camera or a video recorder, is based on the principle of monocular imaging technology. Compound-eye imaging technology has a biomimetic structure similar to insect eyes. A plurality of monocular views can be combined through a multi-camera algorithm to represent an image having a consistent effect as that of monocular imaging but with super-high resolution. With the compound-eye imaging technology, a video recorder can cover a larger monitoring range with a longer monitoring distance. Thus, the monitoring can cover a wide and long range with high clarity.

### SUMMARY

Embodiments of the present disclosure provide a metasurface device, including a plurality of metasurface units and a flexible connection structure. The plurality of metasurface units are arranged in a plane shape spaced apart from each other. Each metasurface unit of the plurality of metasurface units includes a substrate and a plurality of nanostructure units arranged on a side of the substrate. The flexible connection structure connects the plurality of metasurface units.

Embodiments of the present disclosure provide a preparation method for a metasurface device. The method includes providing a metasurface structure including a substrate and a plurality of nanostructure units arranged on one side of the substrate, cutting the metasurface structure to form a plurality of metasurface units arranged in a plane shape and spaced apart from each other, and forming a flexible connection structure connecting the plurality of metasurface units.

Embodiments of the present disclosure provide an optical imaging system including a support structure and one or more metasurface devices. The support structure has a curved surface. Each of the one or more metasurface devices is attached to the curved surface of the support structure and includes a plurality of metasurface units and a flexible connection structure. The plurality of metasurface units are arranged in a plane shape spaced apart from each other. Each metasurface unit of the plurality of metasurface units includes a substrate and a plurality of nanostructure units arranged on a side of the substrate. The flexible connection structure connects the plurality of metasurface units.

### BRIEF DESCRIPTION OF THE DRAWINGS

FIG. 1 is a schematic cross-sectional diagram of a metasurface device according to some embodiments of the present disclosure.

FIG. 2 is a schematic cross-sectional diagram of a metasurface device according to some embodiments of the present disclosure.

FIG. 3 is a schematic cross-sectional diagram of a metasurface device according to some embodiments of the present disclosure.

FIG. 4 is a schematic top view of a metasurface device according to some embodiments of the present disclosure.

FIG. 5 is a schematic top view of a metasurface device according to some embodiments of the present disclosure.

FIG. 6 is a schematic cross-sectional diagram showing a metasurface device applied to an optical imaging system according to some embodiments of the present disclosure.

FIG. 7 is a schematic cross-sectional diagram showing a metasurface device applied to an optical imaging system according to some embodiments of the present disclosure.

FIG. 8 is a schematic cross-sectional diagram showing a metasurface device applied to a spherical panoramic camera according to some embodiments of the present disclosure.

FIG. 9 is a schematic flowchart of a preparation method of a metasurface device according to some embodiments of the present disclosure.

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers. In this disclosure, if a light beam encounters a first element and then reaches a second element, the second element is referred to as being downstream the first element or downstream the first element in an optical path, and correspondingly the first element is referred to as being upstream the second element or upstream the second element in the optical path.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

Metasurface refers to an artificial two-dimensional material. A basic structure unit of metasurface is a nanostructure unit with a size in an order of nanometers and smaller than a working wavelength. Metasurface can realize flexible and effective control of the characteristics, such as propagation direction, polarization mode, amplitude, and phase, of electromagnetic waves. Metasurface can also have an ultra-light characteristic. A metasurface optical device made based on the metasurface device can have good optical performance, small volume, and high integration compared to a conventional optical device.

The metasurface device can be prepared on a wafer using semiconductor processing and can be generally planar. Although a compound-eye imaging system can be used to obtain better imaging quality based on the ultra-light characteristic and excellent optical performance of the metasurface device, a field of view can also be limited because the metasurface device is planar.

Embodiments of the present disclosure provide a metasurface device, a preparation method of the metasurface device, and an optical imaging system. The optical imaging system consistent with the disclosure has a larger field of view, and is suitable for a compound-eye imaging system.

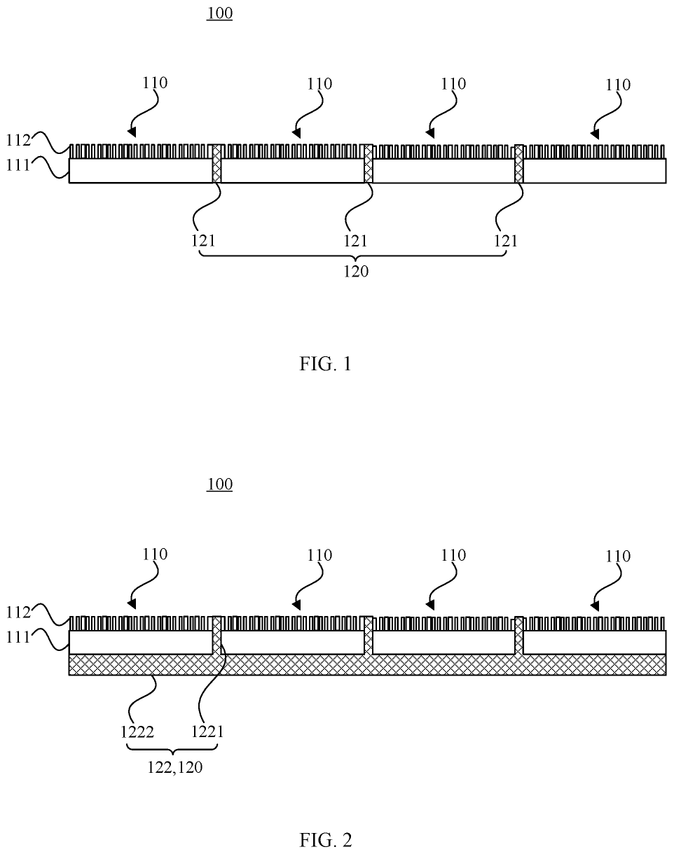

As shown in FIG. 1, embodiments of the present disclosure provide a metasurface device 100. The metasurface device 100 includes a plurality of metasurface units 110 and a flexible connection structure 120. The plurality of metasurface units 110 are arranged in a plane shape and spaced apart from each other. Each metasurface unit 110 includes a substrate 111 and a plurality of nanostructure units 112 arranged on a side of the substrate 111. The flexible connection structure 120 connects the plurality of metasurface units 110.

The metasurface device 100 of embodiments of the present disclosure can be applied to an optical imaging system. The optical imaging system can include one or more metasurface devices 100 with the above structure. The flexible connection structure 120 can be configured to connect the plurality of metasurface units 110. Thus, the metasurface device 100 can be flexible as a whole. As such, the metasurface device 100 can be adhered to a support structure of the optical imaging system with a curved surface. Thus, the optical imaging system can obtain better imaging quality based on the ultra-light characteristic and the good optical performance of the metasurface device. Further, the optical imaging system can be designed to have a larger field of view. In embodiments of the present disclosure, the curved surface of the support structure can be a smooth curved surface or formed by connecting a plurality of planar units into a non-smooth curved surface generally in a curved surface shape.

A specific structure of the flexible connection structure 120 is not limited. As shown in FIG. 1, in some embodiments, the flexible connection structure 120 is a flexible filling structure 121. The flexible filling structure 121 can be filled in gaps between the plurality of metasurface units 110. The flexible connection structure 120 of embodiments of the present disclosure may not increase a thickness of the metasurface device 100. Thus, the metasurface device 100 can be designed light, and the light-transmission efficiency and the flexibility of the metasurface device 100 can be improved.

As shown in FIG. 2, in some embodiments, the flexible connection structure 120 is a flexible cover layer 122, including a first member 1221 and a second member 1222. The first member 1221 can be filled in the gaps between the plurality of metasurface units 110. The second member 1222 can be attached to one of two surfaces of each metasurface unit 110 in a thickness direction of the metasurface unit 110. For example, the second member 1222 can be attached to the substrate 111 as shown in the accompanying drawings or can be attached to the nanostructure unit 112. With this configuration, a contact area between the flexible connection structure 120 and the plurality of metasurface units 110 can be increased. Thus, the structural strength of the metasurface device 100 can be improved. Such a structure can be suitable for a metasurface device 100 with a relatively large size.

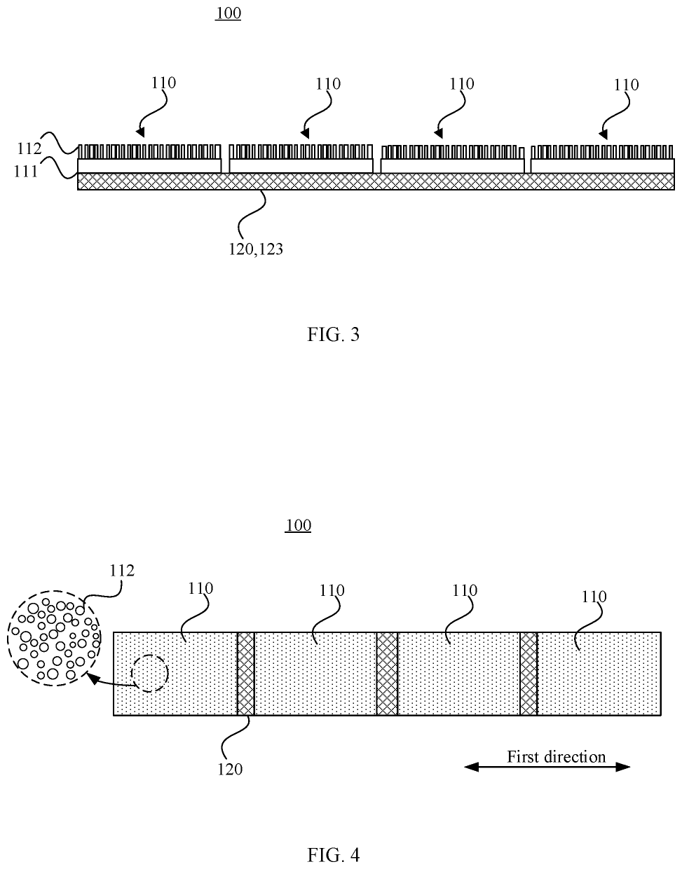

As shown in FIG. 3, in some embodiments, the flexible connection structure 120 is a flexible film layer 123. The flexible film layer 123 can be attached to one of the two surfaces of each metasurface unit 110 in the thickness direction of the metasurface unit 110. For example, the flexible film layer 123 can be attached to the substrate 111 as shown in the figure or can be attached to the nanostructure unit 112. The preparation process of the metasurface device 100 with such a design can be simpler.

In embodiments of the present disclosure, size specifications of the plurality of metasurface units 110 can be the same or not completely same (i.e., at least two metasurface units 110 can have different size specifications). Optical parameters of the plurality of metasurface units 110 (e.g., parameters such as shape, size, and orientation of the nanostructure unit 112) can be the same or not completely same. An arrangement design of the plurality of metasurface units 110 and the size specification and optical parameters of each metasurface unit 110 may need to be designed based on a specific optical application of the metasurface device 100 in the optical imaging system and are not limited here.

As shown in FIG. 4, in some embodiments, the plurality of metasurface units 110 of the metasurface device 100 are arranged at intervals along a first direction (also referred to as a “first arrangement direction” or simply an “arrangement direction”).

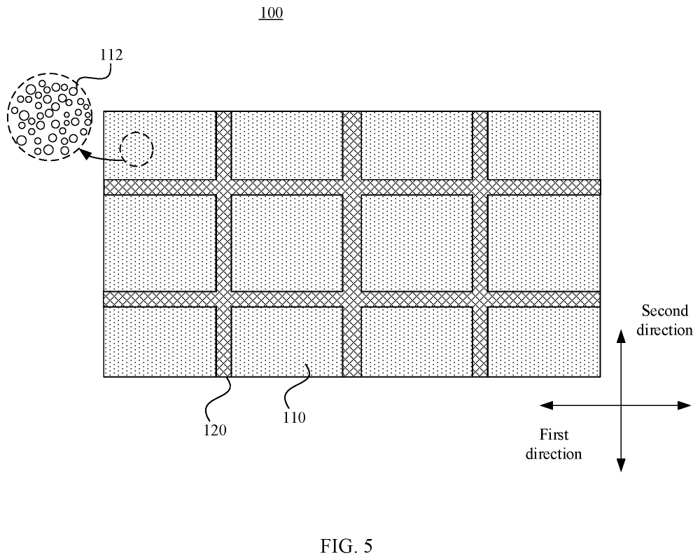

As shown in FIG. 5, in some other embodiments of the present disclosure, the plurality of metasurface units 110 of the metasurface device 100 can also be arranged at intervals along a first direction (also referred to as a “first arrangement direction”) and a second direction (also referred to as a “second arrangement direction”) intersecting with the first direction. The first direction and the second direction can be orthogonal to or at a predetermined angle with each other, or can be a radial direction and a circumferential direction, respectively, of a circle.

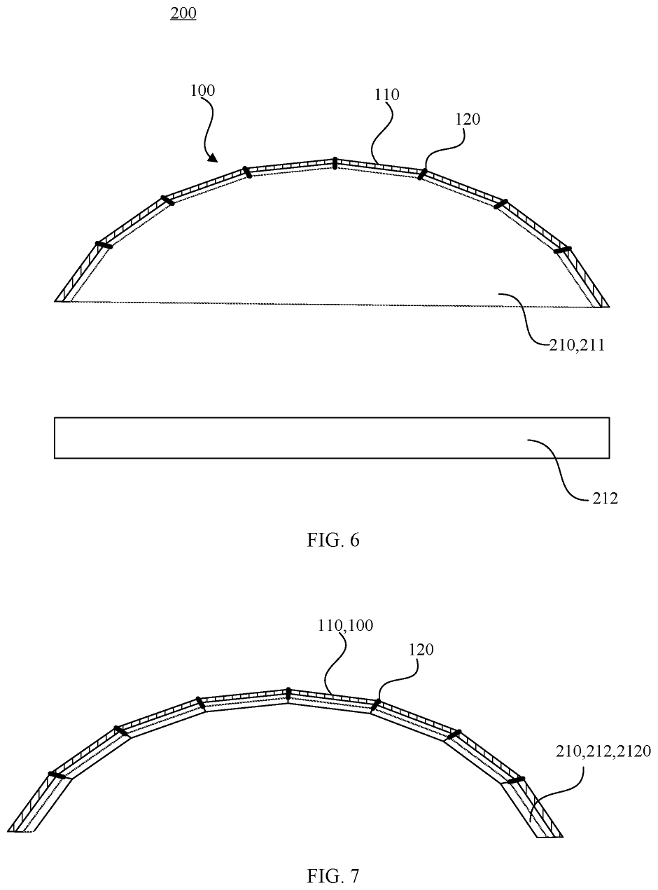

As shown in FIG. 6, embodiments of the present disclosure also provide an optical imaging system 200, including a support structure 210 with a curved surface and at least one metasurface device 100 attached to the curved surface of the support structure 210. The metasurface device 100 can be any metasurface device above. The optical imaging system 200 can include a plurality of optical elements. Only the metasurface device 100, the support structure 210 having a lens structure, and a planar image sensor 212 are shown in the figure.

In some embodiments of the present disclosure, the curved surface of the support structure 210 can be a smooth curved surface or a non-smooth curved surface formed by a plurality of planar units in an approximately curved surface shape. The size specification of the metasurface unit 110 of the metasurface device 100 can be designed according to a curvature of the curved surface and a specific structure of the curved surface. The support structure 210 can be a single optical element or an integrated or assembled structure formed by a plurality of optical elements. The metasurface device 100 can be attached to the curved surface of the support structure 210 by a glue layer.

The optical imaging system 200 can be applied to, for example, a surveillance camera, a virtual reality wearable apparatus, or an augmented reality wearable apparatus, which is not limited here.

In some embodiments, the optical imaging system 200 can be a compound-eye imaging system applied to a compound-eye camera. Because of the bendable design and good optical performance of the metasurface device 100, the compound-eye camera can realize monitoring with a wider and farther range and clearer images, and can image in a larger wavelength range.

As shown in FIG. 6, in some embodiments of the present disclosure, the support structure 210 is a lens 211 (e.g., a convex or concave lens). A surface of the lens 211 can be a smooth curved surface or a surface formed by a plurality of planar units as shown in the figure. The one or more metasurface devices 100 can be attached to the surface of the lens 211.

As shown in FIG. 7, in some embodiments of the present disclosure, the support structure 210 is an image sensor 212 with a curved light-receiving surface. One or more metasurface devices 100 can be attached to the curved light-receiving surface of the image sensor 212. The image sensor 212 with a curved surface is combined of a plurality of splicing units 2120. Each splicing unit 2120 is planar and include a plurality of pixels (not shown in the figure) arranged in an array. The image sensor 212 can be, for example, a complementary metal-oxide-semiconductor (CMOS) sensor or a charge-coupled device (CCD) sensor.

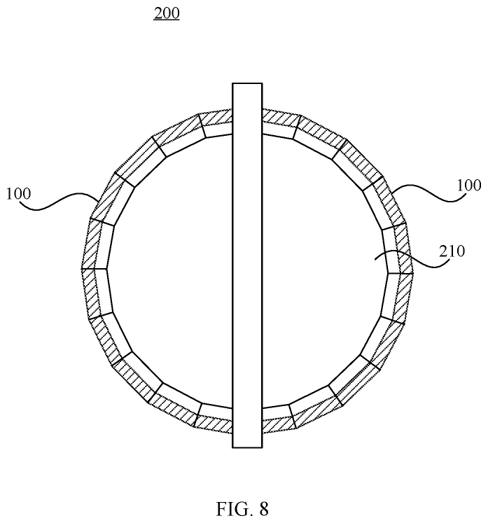

As shown in FIG. 8, in some embodiments of the present disclosure, the support structure 210 (simplified in the figure) has a roughly spherical surface. The optical imaging system 200 includes the plurality of metasurface devices 100 attached to the surface of the support structure 210 and forming a roughly spherical shape. The term “roughly” can be understood as that the combined surface can have characteristics of a sphere but is not required to be a smooth and complete spherical surface and can be a part of a complete spherical surface. The optical imaging system 200 of embodiments of the present disclosure can be applied to a spherical panoramic camera to implement 360-degree full-angle monitoring.

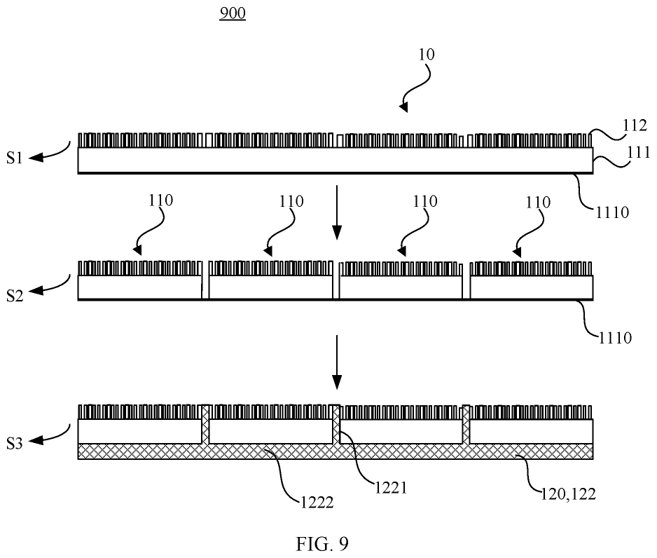

As shown in FIG. 9, embodiments of the present disclosure also provide a preparation method for a metasurface device. The method includes the following processes S1 to S3.

At S1, a metasurface structure 10 is provided. The metasurface structure 10 includes a substrate 111 and a plurality of nanostructure units 112 arranged on one side of the substrate 111.

At S2, the metasurface structure 10 is cut to form the plurality of metasurface units 110 arranged at intervals in a plane shape.

At S3, the flexible connection structure 120 is formed to connect the plurality of metasurface units 110.

A material of the substrate 111 is not limited and can include any one of glass, quartz, polymers, plastic, or a combination thereof. A material of the nanostructure unit 112 is not limited and can include at least one of single crystal silicon, polycrystalline silicon, amorphous silicon, silicon carbide, titanium dioxide, silicon nitride, hafnium oxide, germanium, or III-V compound semiconductors. The III-V compound can be a compound formed by boron, aluminum, gallium, or indium in group III and nitrogen, phosphorus, arsenic, or antimony in group V of the periodic table. For example, the compound can include gallium phosphide, gallium nitride, gallium arsenide, indium phosphide, etc. In embodiments of the present disclosure, a material of the flexible connection structure 120 is not limited and can include, for example, organic silicon, polyethylene terephthalate, or polyethylene.

In process S2, mechanical cutting, laser cutting, or etching process can be used to cut the metasurface structure 10 to form the plurality of metasurface units 110. After the metasurface structure 10 is prepared, a protection film 1110 can be attached to one or two surfaces of the metasurface structure 10. When the cutting is performed in process S2, a cutting depth can be precisely controlled to ensure that the protection film 1110 not be damaged. Thus, arrangement positions of the plurality of metasurface units 110 can be retained by the protection film 1110.

In some embodiments, as shown in FIG. 9, process S3 includes forming a flexible cover layer 122 having a first member 1221 and a second member 1222. The first member 1221 can be filled in the gaps between the plurality of metasurface units 110. The second member 1222 can be attached to one of the two opposite surfaces of each measurface unit 110 in the thickness direction of the metasurface units 110.

In some embodiments, process S3 can further include etching away the second member 1222 of the flexible cover layer 122 (i.e., removing the second member 1222), or etching away a part of the material of the second member 1222 of the flexible cover layer 122 (e.g., the material with a part of thickness or the material in a certain area). Such embodiments may only slightly increase or even does not increase the thickness of the metasurface device 100, thereby is beneficial for light design and improves light-transmission efficiency and flexibility.

In some embodiments, as shown in FIG. 3, process S3 can further include forming a flexible film layer 123 attached to one of the two opposite surfaces of each metasurface unit 110 in the thickness direction of the metasurface unit 110. A preparation process can be simple and convenient.

After one or more metasurface devices 100 are prepared, the one or more metasurface devices can be attached to the support structure having the curved surface. A trench or a protrusion can be arranged at the support structure to assist in positioning the metasurface device 100. Because of the ultra-light characteristic and good optical performance of metasurface, the optical imaging system can achieve better imaging quality and a larger field of view.

Embodiments of the present disclosure have been described here with reference to the accompanying drawings. These different embodiments or examples are exemplary and are not used to limit the scope of the present disclosure. Those skilled in the art can think of various modifications or replacements based on the specification. These modifications and replacements are within the scope of the present disclosure. Thus, the scope of the present invention should be subjected to the scope of the appended claims.

What is claimed is:

1. A metasurface device comprising:
a plurality of metasurface units arranged in a plane shape and spaced apart from each other, each metasurface unit of the plurality of metasurface units including a substrate and a plurality of nanostructure units arranged on a side of the substrate; and
a flexible connection structure connecting the plurality of metasurface units.

2. The metasurface device of claim 1, wherein the flexible connection structure includes a flexible filling structure filled in gaps between the plurality of metasurface units.

3. The metasurface device of claim 1, wherein the flexible connection structure includes a flexible cover layer including:
a first member filled in gaps between the plurality of metasurface units; and
a second member attached to one of two surfaces of each metasurface unit in a thickness direction of the metasurface unit.

4. The metasurface device of claim 1, wherein the flexible connection structure includes a flexible film layer attached to one of two surfaces of each metasurface unit in a thickness direction of the metasurface unit.

5. The metasurface device of claim 1, wherein:
size specifications of the plurality of metasurface units are same.

6. The metasurface device of claim 1, wherein:
at least two of the plurality of metasurface units have different size specifications.

7. The metasurface device of claim 1, wherein:
the plurality of metasurface units are arranged at intervals along an arrangement direction.

8. The metasurface device of claim 1, wherein:
the plurality of metasurface units are arranged at intervals along a first direction and a second direction intersecting with the first direction.

9. A preparation method of a metasurface device comprising:
providing a metasurface structure including a substrate and a plurality of nanostructure units arranged on one side of the substrate;
cutting the metasurface structure to form a plurality of metasurface units arranged in a plane shape and spaced apart from each other; and
forming a flexible connection structure connecting the plurality of metasurface units.

10. The method of claim 9, wherein forming the flexible connection structure includes:
forming a flexible cover layer including:
a first member filled in gaps between the plurality of metasurface units; and
a second member attached to one of two surfaces of each metasurface unit of the plurality of metasurface units in a thickness direction of the metasurface unit.

11. The method of claim 10, wherein forming the flexible connection structure further includes:
etching away the second member of the flexible cover layer.

12. The method of claim 10, wherein forming the flexible connection structure further includes:
etching away a part of the second member of the flexible cover layer.

13. The method of claim 9, wherein forming the flexible connection structure includes:
forming a flexible film layer attached to one of two surfaces of each metasurface unit of the plurality of metasurface units in a thickness direction of the metasurface unit.

14. An optical imaging system comprising:
a support structure having a curved surface; and
one or more metasurface devices attached to the curved surface of the support structure and each including:
a plurality of metasurface units arranged in a plane shape spaced apart from each other, each metasurface unit of the plurality of metasurface units including a substrate and a plurality of nanostructure units arranged on a side of the substrate; and
a flexible connection structure connecting the plurality of metasurface units.

15. The optical imaging system of claim 14, wherein:
the support structure includes a lens.

16. The optical imaging system of claim 14, wherein:
the support structure includes an image sensor with a curved light-receiving surface.

17. The optical imaging system of claim 14, wherein:
the support structure includes a spherical surface; and
the one or more metasurface devices include a plurality of metasurface devices attached to the spherical surface of the support structure and combined in a roughly spherical surface shape.

18. The optical imaging system of claim 14, wherein the optical imaging system includes a compound-eye imaging system.

19. The optical imaging system of claim 14, wherein the flexible connection structure includes a flexible filling structure filled in gaps between the plurality of metasurface units.

20. The optical imaging system of claim 11, wherein the flexible connection structure includes a flexible cover layer including:
a first member filled in gaps between the plurality of metasurface units; and
a second member attached to one of two surfaces of each metasurface unit of the plurality of metasurface units in a thickness direction of the metasurface unit.
